(19) United States
(12) Patent Application Publication
(10) Pub. No.: US 2012/0303483 A1
(43) Pub. Date: Nov. 29, 2012

(54) NEAR FIELD COMMUNICATION (NFC)-BASED PAYMENT SYSTEM AND METHOD

(75) Inventors: Sang-Bum LEE, Goyang-si (KR); Joo-Young YOON, Seoul (KR); Se-Cheol PARK, Incheon (KR)

(73) Assignee: KT CORPORATION, Seongnam-city (KR)

(21) Appl. No.: 13/481,258

(22) Filed: May 25, 2012

(30) Foreign Application Priority Data
May 26, 2011 (KR) 10-2011-0050044

(51) Int. Cl. G06Q 30/06

(52) U.S. Cl. 705/26.41

(57) ABSTRACT

A near field communication (NFC)-based payment method for supporting a payment between seller and purchaser terminals having an NFC module mounted therein. The NFC-based payment method includes: generating and storing a seller code based on seller identification information and sales product information received from the seller terminal, and providing the generated seller code to the NFC module of the seller terminal; generating a purchaser code based on purchaser identification information, purchase product information, and purchase payment information received from the purchaser terminal, matching the purchaser code with the seller code, and storing the purchaser code and the seller code; and transmitting the purchase payment information to the purchaser terminal based on the seller code and the purchaser code which are matched with each other, according to a request of the purchaser terminal acquiring the seller code stored in the NFC module of the seller terminal through NFC.

### CROSS-REFERENCE TO RELATED APPLICATIONS

The present application claims priority from Korean Patent Application No. 10-2011-0050044, filed on May 26, 2011, which is incorporated herein by reference in its entirety.

### BACKGROUND

1. Field

Systems and methods consistent with exemplary embodiments relate to payment technology based on near field communication (NFC); and, more particularly, to an NFC-based payment system and method for safely and conveniently supporting various payment methods other than a cash payment or credit payment using a POS (point of sale) system, during a direct transaction between a seller and a purchaser.

2. Description of Related Art

NFC is a kind of radio frequency identification (RFID) technology for transmitting data between terminals in a short distance of 10 cm through a non-contact NFC module using a frequency band of 13.56 MHz. The NFC is widely used for transmission of product information for supermarkets or general stores, travel information for visitors, traffic and access control locking systems, as well as a payment.

As such, a variety of methods for providing financial services and payment services using a terminal employing the NFC technology which may be more conveniently used by a user have been developed, and an electronic payment method using NFC terminals has been already used widely.

However, although the conventional NFC-based payment system is based on financial transactions between mobile terminals and payment-dedicated terminals, the NFC-based payment system has not yet been applied to an online second-hand transaction based on an online community.

That is, when a seller and a purchaser confirm their transaction intentions for a product online and then meet each other in person to directly conduct a transaction as in the online second-hand transaction, various payment methods excluding a cash payment method or credit payment method using a POS system are not supported.

Meanwhile, with the development and spread of smart phone technology capable of executing various applications (hereinafter, referred to apps), the number of smart phone users has rapidly increased. In consideration of this aspect, when a payment application (app) is installed in a smart phone having an NFC module mounted therein, a payment may be safely and quickly made through the smart phone having an NFC module mounted therein instead of a payment-dedicated POS terminal, during a direct transaction.

### SUMMARY

An exemplary embodiment is directed to an NFC-based payment system and method for safely and quickly supporting an offline direct transaction between a purchaser and a seller after the purchaser and the seller previously register payment and sales information online.

Other aspects of exemplary embodiments can be understood by the following description, and become apparent with reference to the exemplary embodiments. Also, it is obvious to those skilled in the art to which exemplary embodiments pertain that the objects of the exemplary embodiments can be realized by the means as claimed and combinations thereof.

In accordance with an exemplary embodiment, there is provided an NFC-based payment method for supporting a payment between seller and purchaser terminals having an NFC module mounted therein. The NFC-based payment method includes: generating and storing a seller code based on seller identification information and sales product information received from the at least one seller terminal, and providing the generated seller code to the NFC module of the at least one seller terminal; generating a purchaser code based on purchaser identification information, purchase product information, and purchase payment information received from the at least one purchaser terminal, matching the purchaser code with the seller code, and storing the purchaser code and the seller code; and transmitting the purchase payment information to the at least one purchaser terminal based on the seller code and the purchaser code which are matched with each other, according to a request of the at least one purchaser terminal acquiring the seller code stored in the NFC module of the at least one seller terminal through NFC.

The operation of generating and storing the seller code based on the seller identification information and the sales product information received from the at least one seller terminal and the providing the generated seller code to the NFC module of the seller terminal may include: extracting at least one from among device information, operating system (OS) information, and browser information of the at least one seller terminal, which are included in user information received from the at least one seller terminal, and generating a seller system code; generating a seller authentication code for authenticating a seller, based on the user information received from the at least one seller terminal, generating a sales code based on the sales product information received from the at least one seller terminal; and generating the seller code by combining at least two from among the seller system code, the seller authentication code, and the sales code, storing the generated seller code, and transmitting the seller code to the seller terminal such that the seller code is stored in the NFC module of the at least one seller terminal.

The operation of generating the purchaser code based on the purchaser identification information, the purchase product information, and the purchase payment information received from the at least one purchaser terminal, the matching the purchaser code with the seller code, and the storing the purchaser code and the seller code includes: extracting at least one from among device information, operating system (OS) information, and browser information of the at least one purchaser terminal, which are included in user information received from the at least one purchaser terminal, and generating a purchaser system code; generating a purchaser authentication code for authenticating a purchaser based on the user information received from the purchaser terminal; generating a purchase code based on the purchase product information received from the purchaser terminal; receiving information on a payment application (app), which is installed in the at least one purchaser terminal to perforin a payment, from the at least one purchaser terminal, and generating a payment app code; receiving information on a purchase payment, which is to be performed by the payment app, from the at least one purchaser terminal, and generating a payment code; and generating the purchaser code by combining at least two from among the purchaser system code, the purchaser authentication code, the purchase code, the payment app code, and the payment code, matching the purchaser code with the seller code corresponding to the purchaser code, and storing the purchaser code and the seller code.

The operation of transmitting the purchase payment information to the at least one purchaser terminal based on the seller code and the purchaser code which are matched with each other, according to the request of the purchaser terminal acquiring the seller code stored in the NFC module of the at least one seller terminal through NFC, may include: receiving the seller code and the purchaser identification information from the at least one purchaser terminal having acquired the seller code stored in the NFC module of the at least one seller terminal through NFC; extracting at least one from among device information, OS information, and browser information of the at least one seller terminal, seller authentication information, and the sales product information, based on the received seller code; acquiring the purchaser code matched with the seller code based on the seller code and the purchaser identification information; and extracting at least one from among device information, OS information, and browser information of the at least one purchaser terminal, a purchaser authentication code, the purchase product information, a payment application (app) code, and the purchase payment information based on the acquired purchaser code, and transmitting at least the payment app code and the purchase payment information to the purchaser terminal.

In accordance with another exemplary embodiment, there is provided an NFC-based payment system for supporting a payment between seller and purchaser terminals having an NFC module mounted therein. The NFC-based payment system includes: a seller code generation unit configured to generate a seller code based on seller identification information and sales product information received from at least one seller terminal, and configured to provide the generated seller code to the NFC module of the at least one seller terminal; a purchaser code generation unit configured to generate a purchaser code based on purchaser identification information, purchase product information, and purchase payment information received from the at least one purchaser terminal, and configured to match the purchaser code with the seller code; and a code analysis unit configured to transmit the purchase payment information to the at least one purchaser terminal, based on the seller code and the purchaser code which are matched with each other, according to a request of the at least one purchaser terminal acquiring the seller code stored in the NFC module of the seller terminal through NFC. The NFC-based payment system may also include a database which stores and manages the seller code and the purchaser code.

The NFC-based payment system may further include a database which stores and manages the seller code and the purchaser code.

The seller code generation unit may include: a seller system code generator configured to extract at least one from among device information, OS information, and browser information of the at least one seller terminal, which are included in user information received from the at least one seller terminal, and configured to generate a seller system code; a seller authentication code generator configured to generate a seller authentication code for authenticating a seller based on the user information received from the at least one seller terminal; a sales code generator configured to generate a sales code based on the sales product information received from the at least one seller terminal; a code combiner configured to combine at least two from among the seller system code, the seller authentication code, and the sales code and generate a seller code; and a seller code matcher configured to store the generated seller code and transmit the seller code to the at least one seller terminal such that the seller code is stored in the NFC module of the at least one seller terminal.

The purchaser code generation unit may include: a purchaser system code generator configured to extract at least one from among device information, OS information, and browser information of the at least one purchaser terminal, which are included in user information received from the at least one purchaser terminal, and configured to generate a purchaser system code; a purchaser authentication code generator configured to generate a purchaser authentication code for authenticating a purchaser based on the user information received from the at least one purchaser terminal; a purchase code generator configured to generate a purchase code based on the purchase product information received from the at least one purchaser terminal; a payment application (app) code generator configured to receive information on a payment app, which is installed in the at least one purchaser terminal to perform a payment, from the at least one purchaser terminal, and configured to generate a payment app code; a payment code generator configured to receive information on a purchase payment, which is to be performed by the payment application, from the at least one purchaser terminal, and configured to generate a payment code; a code combiner configured to generate a purchaser code by combining at least two from among the seller system code, the purchaser authentication code, the sales code, the payment app code, and the payment code; and a purchaser code matcher configured to match the generated purchaser code with the seller code corresponding to the purchaser code, and store the purchaser code and the seller code.

The code analysis unit may include: a receiver which receives the seller code and purchaser authentication information from the at least one purchaser terminal having acquired the seller code stored in the NFC module of the at least one seller terminal through NFC; a seller code extractor configured to extract at least one from among device information, OS information, and browser information of the at least one seller terminal, seller authentication information, and the sales product information, based on the received seller code; and a purchase information extractor configured to receive the purchaser code matched with the seller code based on the seller code and the purchaser identification information, extract at least one from among device information, OS information, and browser information of the at least one purchaser terminal, a purchaser authentication code, the purchase product information, a payment application code, and the purchase payment information based on the purchaser code, and transmit at least the payment application code and the purchase payment information to the at least one purchaser terminal.

In accordance with yet another exemplary embodiment, there is provided a near field communication (NFC)-based payment method supporting a payment between at least one seller terminal and at least one purchaser terminal, each having an NFC module mounted therein. The NFC-based payment method includes: generating a seller code based on first information related to the at least one seller terminal; generating a purchaser code based on second information related to the at least one purchaser terminal, and matching the purchaser code with the seller code; and transmitting the purchase payment information to the at least one purchaser terminal based on the seller code and the purchaser code which are matched with each other.

The first information may include at least one from among device information, operating system (OS) information, and browser information of the at least one seller terminal. The second information may include at least one from among device information, operating system (OS) information, and browser information of the at least one purchaser terminal.

In accordance with yet another exemplary embodiment, there is provided a near field communication (NFC)-based payment system for supporting a payment between seller and purchaser terminals having an NFC module mounted therein. The NFC-based payment system includes: a seller code generation unit configured to generate a seller code based on first information related to at least one seller terminal; a purchaser code generation unit configured to generate a purchaser code based on second information related to at least one purchaser terminal, and configured to match the purchaser code with the seller code; and a code analysis unit configured to transmit third information to the at least one purchaser terminal, based on the seller code and the purchaser code which are matched with each other.

The first information may include at least one from among device information, operating system (OS) information, and browser information of the at least one seller terminal. The second information may include at least one from among device information, operating system (OS) information, and browser information of the at least one purchaser terminal.

### BRIEF DESCRIPTION OF THE DRAWINGS

FIG. 1 illustrates the concept of the NFC-based payment system and method in accordance with an exemplary embodiment.

FIG. 2 illustrates an environment to which the NFC-based payment system in accordance with an exemplary embodiment is applied.

FIGS. 3A and 3B are a detailed configuration diagram and an operation flow chart of a seller code generation unit included in the NFC-based payment system in accordance with an exemplary embodiment.

FIGS. 4A and 4B are a detailed configuration diagram and an operation flow chart of a purchaser code generation unit included in the NFC-based payment system in accordance with an exemplary embodiment.

FIGS. 5A and 5B are a detailed configuration diagram and an operation flow chart of a code analysis unit included in the NFC-based payment system in accordance with an exemplary embodiment.

### DETAILED DESCRIPTION

Exemplary embodiments will be described below in more detail with reference to the accompanying drawings. The exemplary embodiments may, however, be embodied in different forms and should not be construed as limited to the exemplary embodiments set forth herein. Rather, these exemplary embodiments are provided so that this disclosure will be thorough and complete, and will fully convey the exemplary embodiments to those skilled in the art. Throughout the disclosure, like reference numerals refer to like parts throughout the various figures and exemplary embodiments.

First, the concept of an NFC-based payment system and method in accordance with an exemplary embodiment will be schematically described.

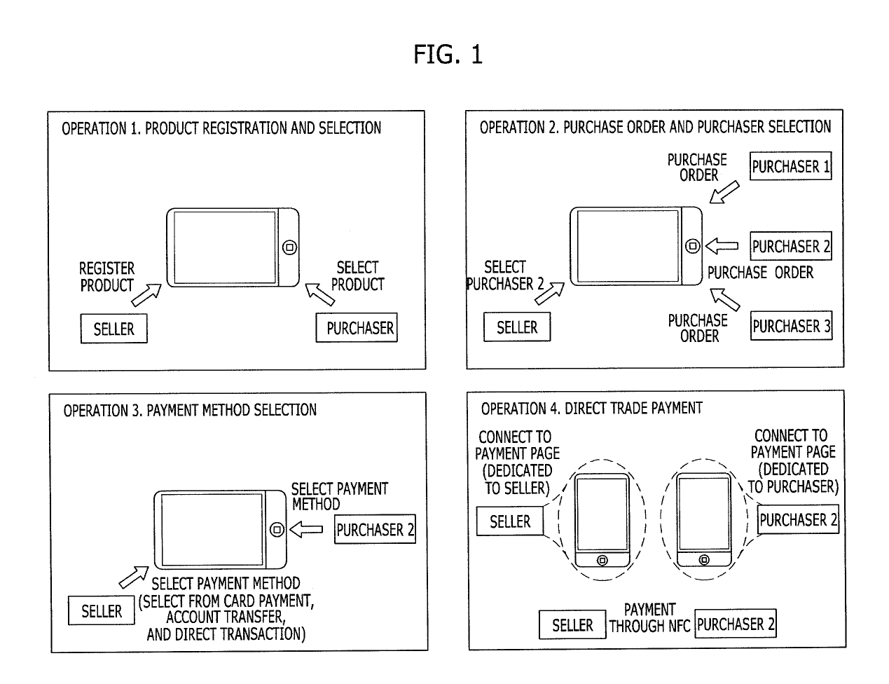

FIG. 1 illustrates the concept of the NFC-based payment system and method in accordance with an exemplary embodiment.

Referring to FIG. 1, when a seller registers sales products in a sales system interconnected with the NFC-based payment system in accordance with an exemplary embodiment, a purchaser checks the sales products (operation 1. product registration and selection). Then, the purchaser selects a product to purchase from the checked products and makes a purchase order. At this time, when a plurality of purchasers make a purchase order for the product, the seller may select a purchaser. In the case of second-hand sales or auction services, the seller may select a purchaser, and in the case of general offline product sales services, the seller sells the product to a plurality of unspecified purchasers (operation 2. purchase order and purchaser selection). Then, the seller provides a mobile payment method (deposit with bank book, credit card payment or the like), and the purchaser selects a payment method (operation 3. payment method selection). Thus, the online confirmation of the transaction intention for the product between the purchaser and the seller is completed. Then, when the purchaser and the seller meet each other in person to directly exchange the product, they connect to their payment pages to make a payment through NFC (operation 4. direct transaction payment).

As described above, an exemplary embodiment is based on a case in which a seller and a purchaser previously match sales information and purchase information, register the matched information in an online system, i.e., a payment system, confirm their transaction intention, and then meet each other in person to directly conduct the transaction.

Hereinafter, the configuration and operation of the NFC-based payment system in accordance with an exemplary embodiment will be described.

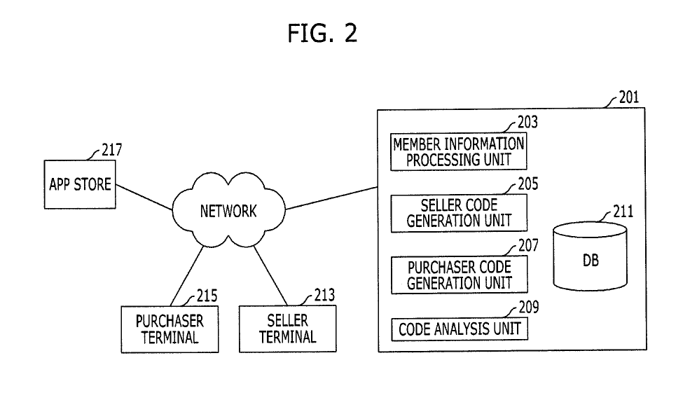

FIG. 2 illustrates an environment to which the NFC-based payment system in accordance with an exemplary embodiment is applied.

Referring to FIG. 2, the NFC-based payment system 201 in accordance with an exemplary embodiment may be connected to a seller terminal 213 and a purchaser terminal 215 through a network such as wireless broadband (WiBro) Internet, WiFi, long-term evolution (LTE) or the like. The network may be connected to an app store 217 which provides a payment app to the purchaser terminal 215 as will be described below. Here, the seller terminal 213 and the purchaser terminal 215 have an NFC module mounted therein, which is capable of exchanging information (for example, a seller code which will be described below) based on NFC.

The NFC-based payment system 201 includes a member information processing unit 203, a seller code generation unit 205, a purchaser code generation unit 207, a code analysis unit 209, and a database 211.

The member information processing unit 203 is configured to receive user information such as member registration information from the seller terminal 213 or the purchaser terminal 215, which may be connected to the network, through an app mounted in the user terminal (for example, an online shopping mall app or the like), and extract information included in a sales information code and a purchase information code which will be described below.

The seller code generation unit 205 is configured to generate a seller code which will be described below, based on the member information extracted by the member information processing unit 203 and seller information and sales product information transmitted from the seller terminal 213.

The purchaser code generation unit 207 is configured to generate a purchaser code which will be described below, based on the member information extracted by the member information processing unit 203, purchaser information, and purchase information transmitted from the purchaser terminal 215.

The code analysis unit 209 is configured to analyze the sales information code and the purchase information code which are generated by the seller code generation unit 205 and the purchaser code generation unit 207, respectively, based on a seller code transmitted from the purchaser terminal 215, and transmit purchase information to the purchaser terminal 215 such that a purchaser may directly make a payment offline, when a seller and the purchaser meet each other in person to directly conduct a transaction.

The database 211 is configured to store and manage the sales information code and the purchase information code which are generated by the seller code information unit 205 and the purchaser code generation unit 207, respectively.

Table 1 shows the details of the seller code and the purchaser code which are generated by the NFC-based payment system 201 in accordance with an exemplary embodiment. The specific descriptions of each code will be made below in a part related thereto.

TABLE 1

| code | Sub codes | Descriptions of sub codes |
|---|---|---|
| Seller | Manager | Code of organization operating payment system |
| code | code | |
| | Seller system | Code containing device and OS information of |
| | code | seller |
| | Seller | Authentication code granted to seller |
| | authentication | |
| | code | |
| | Sales code | Code granted to sales product (containing |
| | | payment method information capable of |
| | | simplifying payment process) |
| Pur- | Manager | Code of organization operating payment system |
| chaser | code | |
| code | Purchaser | Code containing device and OS information of |
| | system code | purchaser |
| | Purchaser | Authentication code granted to purchaser |
| | authentication | |
| | code | |
| | Purchase | Code granted when purchaser make purchase |
| | code | order for sales product (sales code:purchase |
| | | code = 1:N) |
| | App code | Code for payment app executed through NFC |
| | | recognition |
| | Payment | Code granted when purchaser select payment |
| | code | option (account transfer, credit card payment, |
| | | mobile phone payment) |

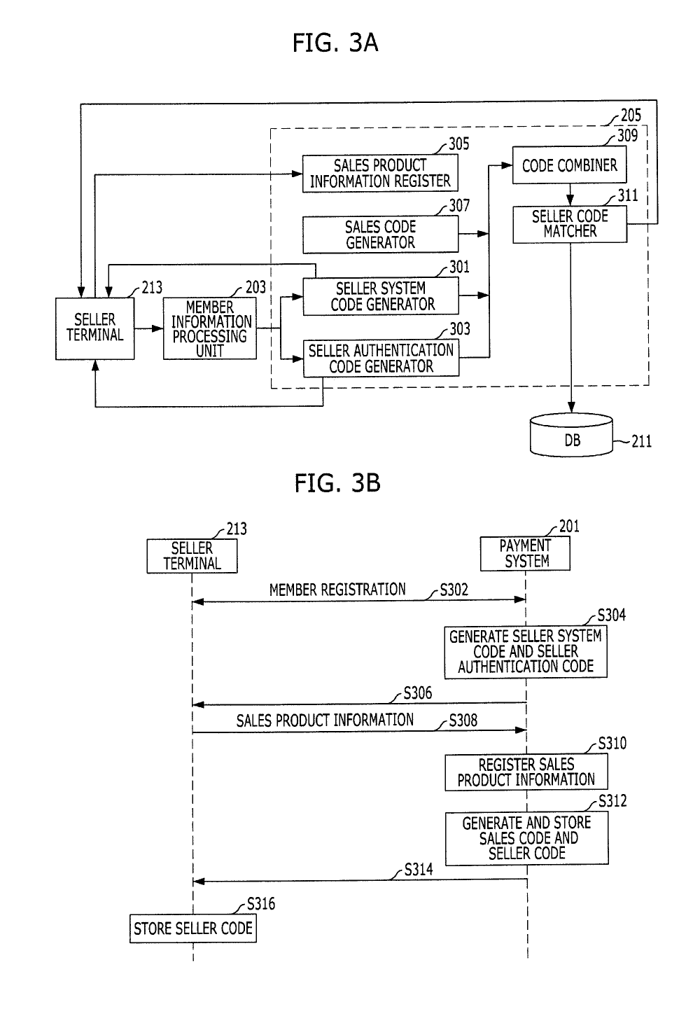

FIGS. 3A and 3B are a detailed configuration diagram and an operation flow chart of the seller code generation unit 205 included in the NFC-based payment system 201 in accordance with an exemplary embodiment.

Referring to FIG. 3A, the seller code generation unit 205 includes a seller system code generator 301, a seller authentication code generator 303, a sales product information register 305, a sales code generator 307, a code combiner 309, and a seller code matcher 311.

The seller system code generator 301 receives user information, inputted when the seller is registered as a member at operation S302, from the member information processing unit 203, extracts device information, OS information, and browser information of the seller terminal 213 which are contained in the user information, and generates a seller system code at operation S304.

The seller authentication code generator 303 receives the user information, inputted when the seller is registered as a member at the operation S302, from the member information processing unit 203, and generates a seller authentication code capable of authenticating the seller based on the user information, at operation S304.

The seller system code and the seller authentication code are transmitted to the seller terminal 213 and stored in an NFC module mounted in the seller terminal 213 at operation S306.

Then, when information on products which the seller intends to sell is transmitted from the seller terminal 213 at operation S308, the sales product information register 305 registers sales product information based on the product information at operation S310.

The sales code generator 307 generates a sales code based on the sales product information registered by the sales product information register 305 at operation S312.

The code combiner 309 receives the seller system code, the seller authentication code, and the sales code from the seller system code generator 301, the seller authentication code generator 303, and the seller code generator 307, respectively, and generates a seller code by combining the received codes, and the seller code matcher 311 stores the seller code generated by the code combiner 309 in the database 211, in order to match the seller code with a purchaser code which will be describe below, at operation S312.

Then, the seller code generated by the code combiner 309 is transmitted to the seller terminal 213 and stored in the NFC module at operation S316.

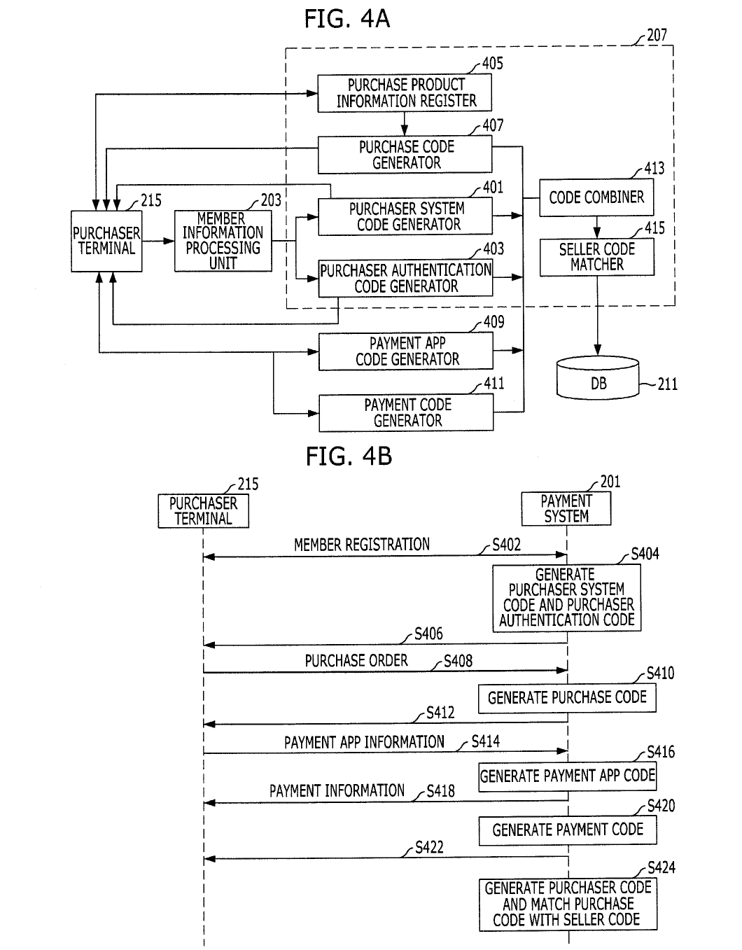

FIGS. 4A and 4B are a detailed configuration diagram and an operation flow chart of the purchaser code generation unit 207 included in the NFC-based payment system 201 in accordance with an exemplary embodiment.

Referring to FIG. 4A, the purchaser code generation unit 207 includes a purchaser system code generator 401, a purchaser authentication code generator 403, a purchase product information register 405, a purchase code generator 407, a payment app code generator 409, a payment code generator 411, a code combiner 413, and a purchaser code matcher 415.

The purchaser system code generator 401 receives user information, inputted when the purchaser is registered as a member at operation S402, from the member information processing unit 203, extracts device information, operating system (OS) information, and browser information of the purchaser terminal 215 which are contained in the user information, and generates a purchaser system code, at operation S404.

The purchaser authentication code generator 403 receives the user information, inputted when the purchaser is registered as a member at the operation S402, from the member information processing unit 203, and generates a purchaser authentication code capable of authenticating the purchaser based on the user information, at operation S404. The authentication code may be matched with a telephone number of the purchaser terminal 215.

The purchaser system code and the purchaser authentication code are transmitted to the purchase terminal 215, and stored in the purchaser terminal 215 at operation S406.

Then, when a purchase order containing information on a product which the purchaser intends to purchase is transmitted from the purchaser terminal 215 at operation S408, the purchase product information register 405 registers the purchase product information based on the purchase order, and the purchase code generator 407 generates a purchase code based on the purchase product information registered by the purchase product information register 405, at operation S410. The generated purchase code has a matching relation of 1:N with the sales code generated by the sales code generator 307. That is, since a plurality of purchase orders may be made for one sales product, a plurality of purchase codes may be matched with one sales code.

The generated purchase code is transmitted to the purchaser terminal 215 and stored in the purchaser terminal 215 at operation S412.

The payment app code generator 409 receives information on a payment app, which is installed in the purchaser terminal 215 to perforin a payment, from the purchaser terminal 215 at operation S414, and generates a payment app code at operation S416. Typically, the payment app is previously downloaded to the purchaser terminal 215 from the app store 217 and then installed and executed. The information on the payment app may include identification information on the payment app or an uniform resource identifier URI for the payment app, for example.

The payment code generator 411 receives information on a purchase payment, which is to be performed by the payment app in the purchaser terminal 215, from the purchase terminal 215 at operation S418, and generates a payment code at operation S420. The purchase payment may include account transfer, credit card payment, and mobile phone payment, for example. Options for the purchase payment may be provided by the seller.

The code combiner 413 receives the purchaser system code, the purchaser authentication code, the sales code, the payment app code, and the payment code from the purchaser system code generator 401, the purchaser authentication code generator 403, the purchase code generator 407, the payment app code generator 409, and the payment code generator 411, respectively, and generates a purchaser code by combining the received codes, and the purchaser code matcher 415 matches the purchaser code generated by the code combiner 413 with a seller code corresponding to the purchaser code, and stores the matching information in the database 211, at operation S424.

In accordance with FIGS. 3 and 4, the seller code generation unit 205 and the purchaser code generation unit 207 previously match the sales information and the purchase information of the seller and the purchaser and register the matching information in an online system, that is, in the NFC-based payment system 201, thereby completing the procedure in which the seller and the purchaser confirm the transaction intention therebetween.

Then, when the seller and the purchaser meet each other in person to conduct a transaction, the NFC-based payment system 201 supports a payment in the transaction. In accordance with an exemplary embodiment, when the seller and the purchaser meet each other to directly conduct a transaction, they may conduct the direct transaction safely and quickly, based on the sales information and the purchase information which have been described with reference to FIGS. 3 and 4, using the terminals having an NFC module mounted therein instead of a payment-dedicated POS terminal. That is, the direct transaction may be safely and quickly conducted through payment apps downloaded to smart phones used by normal consumers or web connection, instead of separate terminals.

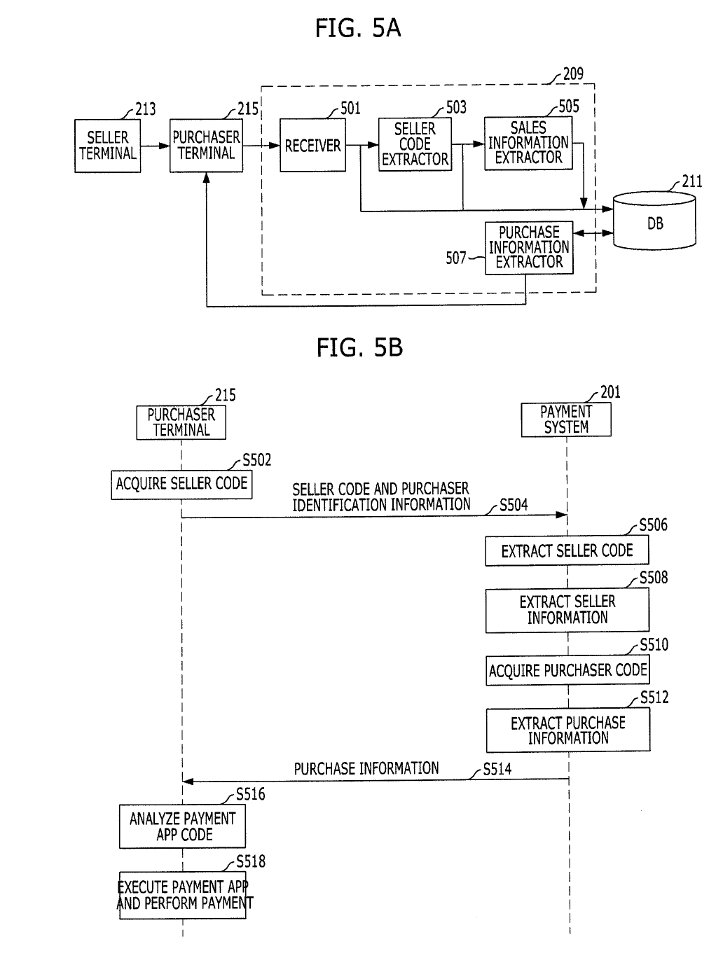

FIGS. 5A and 5B are a detailed configuration diagram and an operation flow chart of the code analysis unit 209 included in the NFC-based payment system 201 in accordance with an exemplary embodiment.

Referring to FIG. 5A, the code analysis unit 209 includes a receiver 501, a seller code extractor 503, a sales information extractor 505, and a purchase information extractor 507.

As described above with reference to FIGS. 3A, 3B, 4A, and 4B, the seller and the purchaser match the sales information and the purchase information of the seller and the purchaser, and register the information in the NFC-based payment system 201, thereby completing the procedure in which they confirm the transaction intention therebetween. Then, when the seller and the purchaser meet each other in person to check and directly conduct a transaction, the purchaser terminal 215 receives and acquires the seller code from the seller terminal 213 through the NFC module mounted therein at operation S502. As described above, the seller terminal 213 and the purchaser terminal 215 have the NFC module capable of exchanging information (for example, a seller code) based on NFC.

The receiver 501 receives purchaser identification information (for example, the telephone number of the purchaser terminal 215) and the seller code of the seller terminal 213 from the purchaser terminal 215 at operation S504.

The seller code extractor 503 extracts the seller code from the information received from the seller terminal 215 by the receiver 501 at operation S506.

The sales information extractor 505 extracts the seller system code, the seller authentication code, and the sales code which form the seller code, extracts the device information, OS information, and browser information of the seller terminal 213, the seller authentication information, and the sales product information from the seller system code, the seller authentication code, and the sales code, respectively, and authenticates the seller based on the extracted information, at operation S508.

Then, the seller code extracted by the seller code extractor 503, the information extracted by the sales information extractor 505, and the purchaser identification information received by the receiver 501 (for example, the telephone number of the purchaser terminal 215) are transmitted to the database 211, and the database 211 acquires a purchaser code matched with the seller code based on the transmitted information, at operation S510.

The purchase information extractor 507 receives the seller code acquired by the database 211, extracts the purchaser system code, the purchaser authentication code, the sales code, the payment app code, and the payment code which form the purchase code, extracts the device information, OS information, and browser information of the purchaser terminal 215, the purchaser authentication code, the purchase product information, information on the payment app which is installed in the purchaser terminal 215 to perform payment (payment app code), and information on a purchase payment which is to be performed by the payment app in the purchaser terminal 215 (for example, account transfer, credit card payment, and mobile phone payment) from the purchaser system code, the purchaser authentication code, the sales code, the payment app code, and the sales code, respectively, and authenticates the purchaser based on the extracted information at operation S512.

The purchaser terminal 215 receives the purchase information extracted by the purchase information extractor 507 at operation S14 and analyzes the payment app code included in the purchase information at operation S516.

The purchaser terminal 215 executes the payment app which is previously installed in the purchaser terminal 215 or downloaded from the app store 217, based on the analyzed payment app code, and performs a payment based on the purchase payment information contained in the received purchase information, at operation S518.

In accordance with an exemplary embodiments, a direct transaction may be safely and quickly conducted through the terminals having the NFC module mounted therein, instead of a payment-dedicated POS terminal. That is, the direct transaction may be safely and quickly conducted through payment apps downloaded to smart phones used by normal consumers or via a web connection, instead of conducting the transaction remotely via separate terminals.

Furthermore, since the spread of smart phones has rapidly increased, a seller may easily utilize an app-type POS function. Through this, it is possible to solve an issue related to a safe transaction which is always a concern during a transaction between individuals.

When the NFC-based payment system and method in accordance with an exemplary embodiment is standardized, it is possible to operate a one-source multi-use system through which various sellers/purchasers may safely and quickly perform a direct transaction.

The above-described methods can also be embodied as computer programs. Codes and code segments constituting the programs may be easily construed by computer programmers skilled in the art to which the invention pertains. Furthermore, the created programs may be stored in computer-readable recording media or data storage media and may be read out and executed by the computers. Examples of the computer-readable recording media include any computer-readable recoding media.

While exemplary embodiments have been described, it will be apparent to those skilled in the art that various changes and modifications may be made without departing from the spirit and scope of the exemplary embodiments as defined in the following claims.

What is claimed is:

1. A near field communication (NFC)-based payment method supporting a payment between at least one seller terminal and at least one purchaser terminal, each having an NFC module mounted therein, comprising:
generating and storing a seller code based on seller identification information and sales product information received from the at least one seller terminal, and providing the generated seller code to the NFC module of the at least one seller terminal;
generating a purchaser code based on purchaser identification information, purchase product information, and purchase payment information received from the at least one purchaser terminal, matching the purchaser code with the seller code, and storing the purchaser code and the seller code; and
transmitting the purchase payment information to the at least one purchaser terminal based on the seller code and the purchaser code which are matched with each other, according to a request of the at least one purchaser terminal acquiring the seller code stored in the NFC module of the at least one seller terminal through NFC.

2. The NFC-based payment method of claim 1, wherein the generating and storing the seller code based on the seller identification information and the sales product information received from the at least one seller terminal and the providing the generated seller code to the NFC module of the seller terminal comprises:
extracting at least one from among device information, operating system (OS) information, and browser information of the at least one seller terminal, which are comprised in user information received from the at least one seller terminal, and generating a seller system code;
generating a seller authentication code for authenticating a seller, based on the user information received from the at least one seller terminal,
generating a sales code based on the sales product information received from the at least one seller terminal; and
generating the seller code by combining at least two from among the seller system code, the seller authentication code, and the sales code, storing the generated seller code, and transmitting the seller code to the seller terminal such that the seller code is stored in the NFC module of the at least one seller terminal.

3. The NFC-based payment method of claim 1, wherein the generating the purchaser code based on the purchaser identification information, the purchase product information, and the purchase payment information received from the at least one purchaser terminal, the matching the purchaser code with the seller code, and the storing the purchaser code and the seller code comprises:
extracting at least one from among device information, operating system (OS) information, and browser information of the at least one purchaser terminal, which are comprised in user information received from the at least one purchaser terminal, and generating a purchaser system code;
generating a purchaser authentication code for authenticating a purchaser based on the user information received from the purchaser terminal;
generating a purchase code based on the purchase product information received from the purchaser terminal;
receiving information on a payment application (app), which is installed in the at least one purchaser terminal to perform a payment, from the at least one purchaser terminal, and generating a payment app code;
receiving information on a purchase payment, which is to be performed by the payment app, from the at least one purchaser terminal, and generating a payment code; and
generating the purchaser code by combining at least two from among the purchaser system code, the purchaser authentication code, the purchase code, the payment app code, and the payment code, matching the purchaser code with the seller code corresponding to the purchaser code, and storing the purchaser code and the seller code.

4. The NFC-based payment method of claim 1, wherein the transmitting the purchase payment information to the at least one purchaser terminal based on the seller code and the purchaser code which are matched with each other, according to the request of the purchaser terminal acquiring the seller code stored in the NFC module of the at least one seller terminal through NFC, comprises:
receiving the seller code and the purchaser identification information from the at least one purchaser terminal having acquired the seller code stored in the NFC module of the at least one seller terminal through NFC;
extracting at least one from among device information, OS information, and browser information of the at least one seller terminal, seller authentication information, and the sales product information, based on the received seller code;
acquiring the purchaser code matched with the seller code based on the seller code and the purchaser identification information; and
extracting at least one from among device information, OS information, and browser information of the at least one purchaser terminal, a purchaser authentication code, the purchase product information, a payment application (app) code, and the purchase payment information based on the acquired purchaser code, and transmitting at least the payment app code and the purchase payment information to the purchaser terminal.

5. A near field communication (NFC)-based payment system for supporting a payment between seller and purchaser terminals having an NFC module mounted therein, the NFC-based payment system comprising:
a seller code generation unit configured to generate a seller code based on seller identification information and sales product information received from at least one seller terminal, and configured to provide the generated seller code to the NFC module of the at least one seller terminal;
a purchaser code generation unit configured to generate a purchaser code based on purchaser identification information, purchase product information, and purchase payment information received from at least one purchaser terminal, and configured to match the purchaser code with the seller code; and
a code analysis unit configured to transmit the purchase payment information to the at least one purchaser terminal, based on the seller code and the purchaser code which are matched with each other, according to a request of the at least one purchaser terminal acquiring the seller code stored in the NFC module of the seller terminal through NFC

6. The NFC-based payment system of claim 5, further comprising a database which stores and manages the seller code and the purchaser code.

7. The NFC-based payment system of claim 5, wherein the seller code generation unit comprises:
a seller system code generator configured to extract at least one from among device information, OS information, and browser information of the at least one seller terminal, which are comprised in user information received from the at least one seller terminal, and configured to generate a seller system code;
a seller authentication code generator configured to generate a seller authentication code for authenticating a seller based on the user information received from the at least one seller terminal;
a sales code generator configured to generate a sales code based on the sales product information received from the at least one seller terminal;
a code combiner configured to combine at least two from among the seller system code, the seller authentication code, and the sales code and generate a seller code; and
a seller code matcher configured to store the generated seller code and transmit the seller code to the at least one seller terminal such that the seller code is stored in the NFC module of the at least one seller terminal.

8. The NFC-based payment system of claim 7, wherein the purchaser code generation unit comprises:
a purchaser system code generator configured to extract at least one from among device information, OS information, and browser information of the at least one purchaser terminal, which are comprised in user information received from the at least one purchaser terminal, and configured to generate a purchaser system code;
a purchaser authentication code generator configured to generate a purchaser authentication code for authenticating a purchaser based on the user information received from the at least one purchaser terminal;
a purchase code generator configured to generate a purchase code based on the purchase product information received from the at least one purchaser terminal;
a payment application (app) code generator configured to receive information on a payment app, which is installed in the at least one purchaser terminal to perform a payment, from the at least one purchaser terminal, and configured to generate a payment app code;
a payment code generator configured to receive information on a purchase payment, which is to be performed by the payment application, from the at least one purchaser terminal, and configured to generate a payment code;
a code combiner configured to generate a purchaser code by combining at least two from among the seller system code, the purchaser authentication code, the sales code, the payment app code, and the payment code; and
a purchaser code matcher configured to match the generated purchaser code with the seller code corresponding to the purchaser code, and store the purchaser code and the seller code.

9. The NFC-based payment system of claim 5, wherein the code analysis unit comprises:
a receiver which receives the seller code and purchaser authentication information from the at least one purchaser terminal having acquired the seller code stored in the NFC module of the at least one seller terminal through NFC;
a seller code extractor configured to extract at least one from among device information, OS information, and browser information of the at least one seller terminal, seller authentication information, and the sales product information, based on the received seller code; and
a purchase information extractor configured to receive the purchaser code matched with the seller code based on the seller code and the purchaser identification information, extract at least one from among device information, OS information, and browser information of the at least one purchaser terminal, a purchaser authentication code, the purchase product information, a payment application code, and the purchase payment information based on the purchaser code, and transmit at least the payment application code and the purchase payment information to the at least one purchaser terminal.

10. A near field communication (NFC)-based payment method supporting a payment between at least one seller terminal and at least one purchaser terminal, each having an NFC module mounted therein, comprising:
generating a seller code based on first information related to the at least one seller terminal;
generating a purchaser code based on second information related to the at least one purchaser terminal, and matching the purchaser code with the seller code; and
transmitting the purchase payment information to the at least one purchaser terminal based on the seller code and the purchaser code which are matched with each other.

11. The NFC-based payment method of claim 10, wherein the first information comprises at least one from among device information, operating system (OS) information, and browser information of the at least one seller terminal.

12. The NFC-based payment method of claim 10, wherein the second information comprises at least one from among device information, operating system (OS) information, and browser information of the at least one purchaser terminal.

13. A near field communication (NFC)-based payment system for supporting a payment between seller and purchaser terminals having an NFC module mounted therein, the NFC-based payment system comprising:
a seller code generation unit configured to generate a seller code based on first information related to at least one seller terminal;
a purchaser code generation unit configured to generate a purchaser code based on second information related to at least one purchaser and configured to match the purchaser code with the seller code; and
a code analysis unit configured to transmit third information to the at least one purchaser terminal, based on the seller code and the purchaser code which are matched with each other.

14. The NFC-based payment system of claim 13, wherein the first information comprises at least one from among device information, operating system (OS) information, and browser information of the at least one seller terminal.

15. The NFC-based payment system of claim 13, wherein the second information comprises at least one from among device information, operating system (OS) information, and browser information of the at least one purchaser terminal.
